(19) United States
(12) Patent Application Publication
(10) Pub. No.: US 2014/0238013 A1
(43) Pub. Date: Aug. 28, 2014

(54) VANADIUM DIOXIDE MICROACTUATORS

(71) Applicants: Junqiao Wu, Richmond, CA (US); Kai Liu, Albany, CA (US); Kevin Wang, Berkeley, CA (US)

(72) Inventors: Junqiao Wu, Richmond, CA (US); Kai Liu, Albany, CA (US); Kevin Wang, Berkeley, CA (US)

(73) Assignee: THE REGENTS OF THE UNIVERSITY OF CALIFORNIA, Oakland, CA (US)

(21) Appl. No.: 14/067,555

(22) Filed: Oct. 30, 2013

Related U.S. Application Data
(60) Provisional application No. 61/724,724, filed on Nov. 9, 2012.

(51) Int. Cl. F03G 7/06

(52) U.S. Cl. CPC F03G 7/06
USPC 60/528; 216/51

(57) ABSTRACT

This disclosure provides systems, methods, and apparatus related to vanadium dioxide microactuators. In one aspect, a method includes depositing a vanadium dioxide layer on a sacrificial layer disposed on a substrate. A metal layer is deposited on the vanadium dioxide layer. The metal layer is patterned. Portions of the vanadium dioxide layer that are not covered by the metal layer are removed. At least a portion of the sacrificial layer is removed to form a cantilever-type structure including the vanadium dioxide layer and the metal layer disposed on the vanadium dioxide layer.

### RELATED APPLICATIONS

This application claims priority to U.S. Provisional Patent Application No. 61/724,724, filed Nov. 9, 2012, which is herein incorporated by reference.

### STATEMENT OF GOVERNMENT SUPPORT

This invention was made with government support under Contract No. DE-AC02-05CH11231 awarded by the U.S. Department of Energy, Early Career Award DE-FG02-11ER46796 awarded by the U.S. Department of Energy, Grant No. ECCS-1101779 awarded by the National Science Foundation, and Grant No. EEC-0832819 awarded by the National Science Foundation. The government has certain rights in this invention.

### TECHNICAL FIELD

This disclosure is related to microactuators, and more specifically to vanadium dioxide micro actuators.

### BACKGROUND

Direct conversion of external stimuli to mechanical motion at the microscale to nanoscale is of importance in advanced technologies including micro- and nano-electromechanical systems, micro-robotics, and biomimetics. A wide range of materials featuring different stimuli-responsive properties are used for the actuation. On the inorganic side, differential thermal expansion, piezoelectric ceramics, and shape memory alloys (SMAs) are typically utilized. The relative size change (i.e., strain) in these systems is usually low (except for SMAs), on the order of 10⁻⁴˜10⁻³ even at strong stimuli such as high operating voltage or large temperature change. Consequently, they typically output small displacements far shorter than the actuator length, even with magnification mechanisms such as being assembled in a bimorph structure. Actuators based on polymers or carbon nanotubes exhibit high flexibility and large size change, but their intrinsically low response speed, weak force output, and incompatibility with present microfabrication processes present limitations.

### SUMMARY

Various mechanisms are currently exploited to transduce a wide range of stimulating sources into mechanical motion. At the microscale, simultaneous high amplitude, high work output, and high speed in actuation are hindered by limitations of these actuation mechanisms. A set of microactuators fabricated by a microfabrication process, showing simultaneous high performance by these metrics, operated on the structural phase transition in vanadium dioxide responding to diverse stimuli of heat, electric current, and light, are described herein. In both ambient and aqueous conditions, the actuators can bend with high displacement-to-length ratios of up to 1 in the sub-100 μm length scale, work densities over 0.63 J/cm³, and at frequencies up to 6 kHz. The functionalities of actuation can be further enriched with integrated designs of planar as well as three-dimensional geometries. Combining high performance, high durability, diversity in responsive stimuli, versatile working environments, and microscale manufacturability, these actuators offer potential applications in micro-electromechanical systems, microfluidics, robotics, drug delivery, and artificial muscles.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a flow diagram illustrating a manufacturing process for an array of micro actuators.

FIGS. 2A-2D show examples of isometric illustrations of an array of microactuators at various stages in the manufacturing process.

FIGS. 3A-3C show examples of schematic illustrations of microactuators.

FIGS. 4A and 4B show examples of micrographs of thermally activated micro actuators.

FIGS. 5A-5C show examples of schematic diagrams and a micrograph of electrically activated micro actuators.

FIGS. 6A-6C show examples of micrographs of optically activated microactuators.

FIGS. 7A-7C show examples of micrographs of microactuators.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

### Introduction

The fundamental reason that high amplitude and high force tend to be mutually exclusive is related to the limited output work density. The volumetric work density describes the maximum mechanical work output per unit volume of active material that drives the actuation. It is given by E·∈²/2, where E is the Young's modulus of the active material, which determines the strength of force, and ∈ is the maximum strain, which limits the actuation amplitude. A plot of E versus ∈ of a range of active materials for actuation can be used to for comparison to vanadium dioxide (VO₂), the material used in some of the embodiments described herein. It can be seen that owing to its simultaneously high E (˜140 GPa) and high ∈ (˜1% in single crystals), a work density as high as 7 J/cm³ is theoretically possible by using VO₂ as the driving material. This is comparable to SMAs, over an order of magnitude higher than that of inorganic materials and electrostrictive polymers, and three orders of magnitude higher than human muscles (˜0.008 J/cm³). On the other hand, although being able to deliver high work densities, SMAs need a wide temperature variation for reactivation in cyclic actuation; moreover, when thickness is reduced to the sub-micron scale, SMAs tend to lose the memory function owing to martensite-austenite phase compatibility issues. As a result, SMA actuators are currently limited to low operating frequencies and low displacement to length ratios.

VO₂ undergoes a thermally driven metal-insulator phase transition (MIT) accompanied by a structural transition slightly above room temperature (67° C.). As its lattice changes from a monoclinic (insulating, I) to a rutile (metallic, M) structure upon heating across the MIT, VO₂ shrinks by a transformation strain of ∈˜1% along the c axis of the rutile phase (c_{R}), while expanding along the other two directions. Combining the high E which is expected for a transition metal oxide, the high ∈, the low stimulating temperature needed, and the intrinsically fast MIT process (˜pico-second), VO₂ rises as an ideal driving material for microscale actuation.

### Methods of Fabrication and Devices

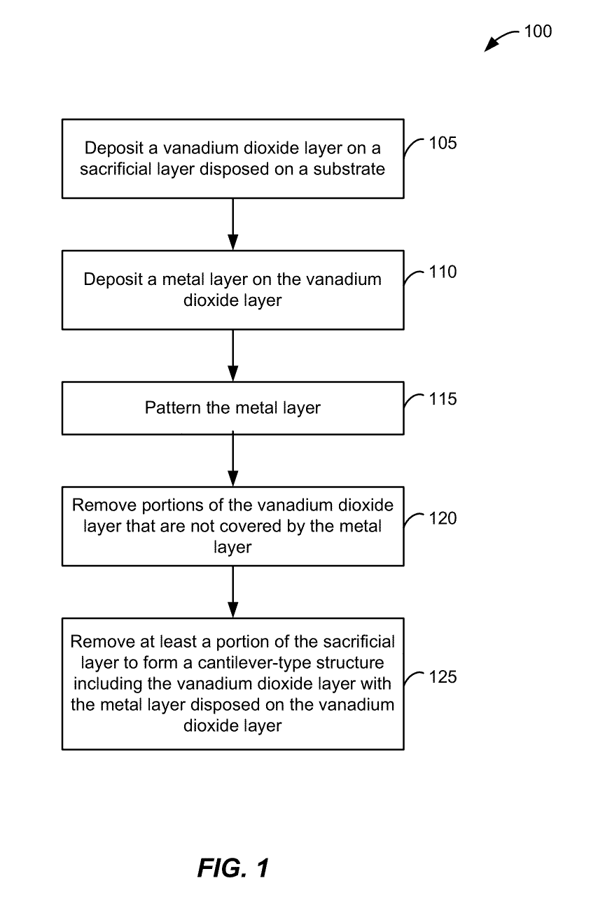

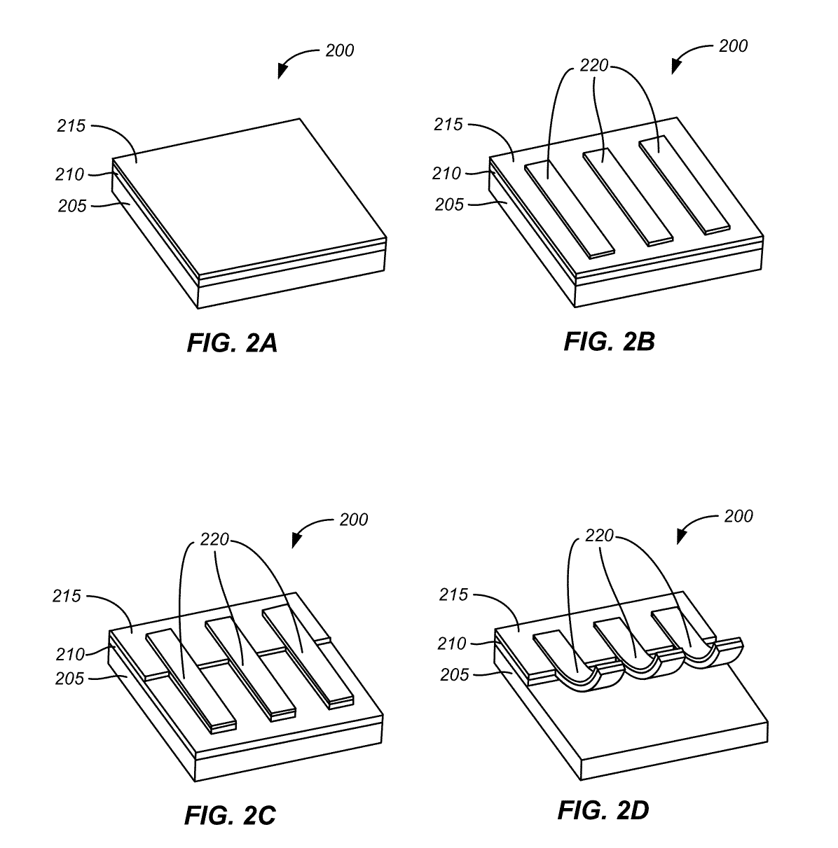

FIG. 1 shows an example of a flow diagram illustrating a manufacturing process for an array of microactuators. FIGS. 2A-2D show examples of isometric illustrations of an array of microactuators at various stages in the manufacturing process.

Starting at block 105 of the process 100 shown in FIG. 1, a vanadium dioxide (VO₂) layer is deposited on a sacrificial layer disposed on a substrate. The vanadium dioxide layer may be deposited using many different processes. In some embodiments, the vanadium dioxide layer is deposited using an atomic layer deposition process (ALD), a chemical vapor deposition process (CVD), a physical vapor deposition (PVD) process (e.g., pulsed laser deposition (PLD)), a reactive molecular beam epitaxy (MBE) process, or a sol-gel process. In some embodiments, a PLD process may generate a higher purity VO₂ layer compared to other processes. In some embodiments, the vanadium dioxide layer is about 50 nanometers (nm) to 1 micron thick or about 100 nm to 300 nm thick. In some embodiments, the deposited VO₂ layer is a polycrystalline VO₂ layer. In some embodiments, the polycrystalline VO₂ layer is textured; texture is the distribution of crystallographic orientations of a polycrystalline sample. In some embodiments, the VO₂ layer is textured, with the c_{R} axis lying substantially parallel to a plane of the substrate.

The sacrificial layer is a layer that may be removed from the substrate. The sacrificial layer may comprise any material that has an etch selectivity against VO₂, and can be removed from the substrate underneath the VO₂ layer (i.e., removed from between the substrate and the VO₂ layer). In some embodiments, the sacrificial layer comprises an oxide layer. In some embodiments, the sacrificial layer comprises silicon oxide (e.g., SiO₂). In some embodiments, the sacrificial layer is about 0.1 microns to 20 microns thick or about 0.6 microns to 1.7 microns thick. The substrate may by any material that is capable of supporting the microactuators being fabricated. In some embodiments, the substrate comprises a silicon substrate. In some embodiments, the sacrificial layer disposed on the substrate is disposed on an entire side of the substrate. In some embodiments, depositing the VO₂ layer includes depositing the VO₂ on the sacrificial layer to completely cover the sacrificial layer.

FIG. 2A shows an example of an isometric illustration of the array of microactuators 200 at this point (e.g., up though block 105) in the process 100. The array of microactuators 200 includes a substrate 205, a sacrificial layer 210 disposed on the substrate 205, and a VO₂ layer 215 disposed on the sacrificial layer 210.

Returning to FIG. 1, at block 110, a metal layer is deposited on the VO₂ layer. The metal layer may be deposited using many different processes. In some embodiments, the metal layer is deposited using an ALD process, a CVD process, a PVD process (e.g., a sputtering process), or an electron-beam evaporation process. In some embodiments, a metal of the metal layer is selected from a group consisting of chromium, nickel, and titanium.

The thickness of the metal layer may be determined by the modulus of elasticity of the metal. For example, when the metal has a high modulus of elasticity, a thin metal layer may be deposited. In some embodiments, the metal layer is about 15 nm to 500 nm thick or about 25 nm to 75 nm thick. In some embodiments, the metal layer is up to about 1 micron thick. In the case of chromium, a metal layer of chromium may be about 0.3 times to 0.5 times the thickness of the VO₂ layer deposited at block 105.

At block 115, the metal layer is patterned. The metal layer may be patterned to define the shape of the array of microactuators. In some embodiments, the metal layer is patterned using photolithography techniques and lift-off techniques that include masking processes and etching processes.

FIG. 2B shows an example of an isometric illustration of the array of microactuators 200 at this point (e.g., up though block 115) in the process 100. The array of microactuators 200 includes the substrate 205, the sacrificial layer 210 disposed on the substrate 205, the VO₂ layer 215 disposed on the sacrificial layer 210, and the patterned metal layer 220. The patterned metal layer 220 shown in FIG. 2B includes three rectangular-shaped lines of metal.

Returning to FIG. 1, at block 120 portions of the VO₂ layer that are not covered by the metal layer are removed. In some embodiments, the portions of the VO₂ layer are removed by an etching process or a dry etching process. In some embodiments, the portions of the VO₂ layer are removed by a reactive-ion etching (RIE) process. When using an RIE process, the metal layer may serve as a mask and prevent the VO₂ layer underlying the metal layer from being etched.

FIG. 2C shows an example of an isometric illustration of the array of microactuators 200 at this point (e.g., up though block 120) in the process 100. The array of microactuators 200 includes the substrate 205, the sacrificial layer 210 disposed on the substrate 205, the VO₂ layer 215 disposed on the sacrificial layer 210, and the patterned metal layer 220 disposed on the VO₂ layer 215. A portion of the VO₂ layer 215 at the front of the array of microactuators 200 has been removed.

Returning to FIG. 1, at block 125 at least a portion of the sacrificial layer is removed to form a cantilever-type structure including the VO₂ layer and the metal layer disposed on the VO₂ layer. In some embodiments, a portion of the VO₂ layer is disposed on the sacrificial layer, and a portion of the VO₂ layer is not disposed on the sacrificial layer (i.e., a portion of the VO₂ layer is not supported by the sacrificial layer and is in free space). In some embodiments, the portion of the sacrificial layer may be removed by an etching process, such as a wet etching process, for example. For example, when the sacrificial layer comprises SiO₂, a buffered oxide etchant may be used to remove the portion of the sacrificial layer.

FIG. 2D shows an example of an isometric illustration of the array of microactuators 200 at this point (e.g., up though block 125) in the process 100. The array of microactuators 200 includes the substrate 205, the sacrificial layer 210 disposed on the substrate 205, the VO₂ layer 215, and the patterned metal layer 220 disposed on the VO₂ layer 215. The sacrificial layer 210 on a portion of the substrate 205 has been removed, leaving one end of each of the three rectangular-shaped lines of metal and VO₂ disposed on the sacrificial layer, and leaving one end of each of the three rectangular-shaped lines of metal and VO₂ not disposed on the sacrificial layer and being in free space. Each of the three rectangular-shaped lines of metal and VO₂ forms a cantilever (i.e., a beam anchored at only one end).

Depending on the temperature at which the metal deposition at block 110 is performed, the array of microactuators may curve towards to the metal layer, as shown in FIG. 2D, or may remain in a planar configuration. For example, when the metal layer is deposited at a temperature greater than about 67° C., the array of microactuators will curve towards the metal layer because the metal layer was deposited onto the VO₂ layer at a temperature higher than the VO₂ MIT temperature. When the metal layer is deposited at a temperature less than about 67° C., the array of microactuators will remain in a planar configuration because the metal layer was deposited onto VO₂ layer at a temperature lower than the VO₂ MIT temperature.

With the completion of block 125, the fabrication of the array of microactuators is complete. Further process operations may be performed after the completion of the process 100, however. Also, additional process operations may be performed while performing the process 100.

For example, additional patterning operations, including masking processes and etching processes, may be performed in the process 100. In some embodiments, the process 100 includes depositing a photoresist on a portion of the patterned metal layer and the vanadium dioxide layer before block 120. This photoresist may aid in preventing etching of the VO₂ layer that remains disposed on the sacrificial layer during the VO₂ layer removal at block 120. In some embodiments, at block 120, portions of the VO₂ layer that are not covered by the metal layer and the photoresist are removed. In some embodiments, after block 125 is completed, the photoresist is removed.

In some embodiments, after block 115 the metal layer is thermally annealed. In some embodiments, the metal layer is thermally annealed at about 150° C. to 500° C. for about 60 seconds to 180 seconds or at about 150° C. to 300° C. for about 60 seconds to 180 seconds. Thermally annealing the metal layer may aid in the adhesion of the metal layer to the VO₂ layer, aid in preventing delamination of the metal layer and the VO₂ layer, and may improve the actuation performance of the array of microactuators.

In some embodiments, after block 105, a wetting layer is deposited on the VO₂ layer. Depending on the metal of the metal layer, a wetting layer may allow a specific metal to be deposited on the VO₂ layer and/or improve the adhesion of the metal layer to the VO₂ layer. In some embodiments, the wetting layer comprises a dielectric material or a metal. In some embodiments, the wetting layer comprises chromium or titanium.

In some embodiments, the metal layer is printed on the VO₂ layer. Printing a metal layer on the VO₂ layer may obviate the need for patterning the metal layer in block 115.

In some embodiments, a layer of a ceramic material or a polymer material is deposited on the VO₂ layer instead of a metal layer. A layer of a ceramic material or a polymer material may be used, depending on the application of the array of microactuators.

In some embodiments, after block 125 is completed, a polymer layer is attached to the array of microactuators. For example, the polymer layer may comprise a planar sheet of material, and attaching the polymer layer to the array of microactuators may allow the polymer layer to be rotated about an axis when the array of microactuators is actuated. In some embodiments, the polymer of the polymer layer is a flexible polymer. In some embodiments, the polymer of the polymer layer is selected from a group consisting of polydimethylsiloxane (PDMS) and polyurethane. In some embodiments, the polymer layer is about 3 microns to 1 millimeter (mm) thick. In some embodiments, the array of microactuators may be heated to above about 67° C. when attaching the polymer layer to the array so that the array of microactuators is in a planar configuration. In some embodiments, the polymer layer aids in protecting the array of microactuators. In some embodiments, the polymer layer makes for a larger area surface that moves when the array of microactuators is actuated.

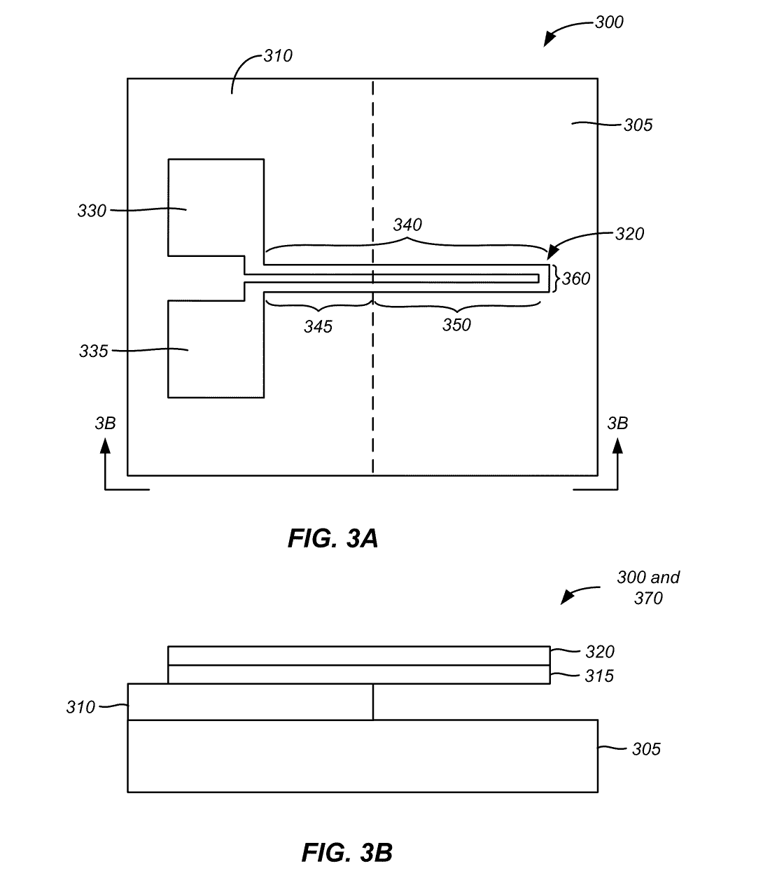

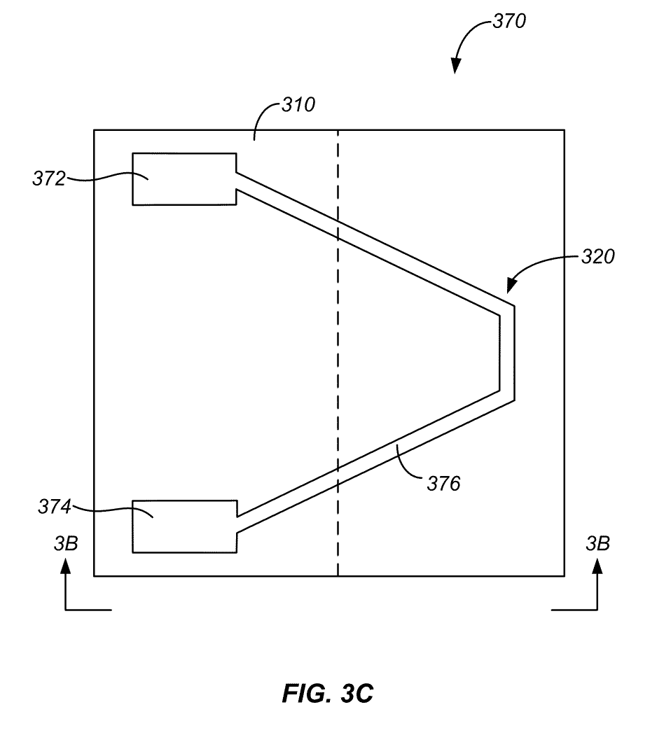

While the process 100 in FIG. 1 was described with respect to manufacturing an array of microactuators, a single microactuator or an array of microactuators having a number of different configurations, lengths, and widths, including the microactuators shown in EXAMPLE 1 and EXAMPLE 2, below, may be fabricated with the process 100. For example, the microactuators described with respect to FIGS. 3A-3C can be manufactured with the process 100.

FIGS. 3A-3C show examples of schematic illustrations of microactuators. FIG. 3A shows a top-down schematic illustration of a microactuator 300. FIG. 3C shows a top-down schematic illustration of a microactuator 370. FIG. 3B shows a cross-sectional illustration of the microactuators 300 and 370.

As shown in FIG. 3B, the microactuator 300 comprises a substrate 305 and a sacrificial layer disposed on the substrate 310. The microactuator 300 further comprises a VO₂ layer 315 and a metal layer 320 disposed on the VO₂ layer 315. The VO₂ layer 315 and the metal layer 320 form a cantilever-type structure, with a portion of the VO₂ layer 315 being disposed on the sacrificial layer 310 and a portion of the VO₂ layer 315 not being disposed on the sacrificial layer 310 (i.e., a portion of the VO₂ layer 315 not being supported by the sacrificial layer 310 and being in free space).

In some embodiments, the substrate 305 is a silicon substrate. The sacrificial layer 310 may be any material that can be removed from the substrate 305. In some embodiments, the sacrificial layer 310 comprises an oxide layer. In some embodiments, the sacrificial layer 310 comprises a SiO₂ layer. In some embodiments, the sacrificial layer 310 is about 0.1 microns to 20 microns thick. In some embodiments, the VO₂ layer 320 is about 50 nanometers to 1 micron thick. In some embodiments, the metal layer 315 is selected from a group consisting of chromium, nickel, and titanium. In some embodiments, the metal layer 315 is about 15 nanometers to 500 nanometers thick.

In the top-down view of the microactuator 300 shown in FIG. 3A, the substrate 305, the sacrificial layer 310, and the VO₂ layer 320 are visible. Not visible is the metal layer 315, as it is covered by the VO₂ layer 320. The metal layer 315 and the VO₂ layer 320 form a pattern including a first electrode 330, a second electrode 335, and a line 340. A first end of the line 340 of the metal layer 315 and the VO₂ layer 320 is connected to the first electrode 330, and a second end of the line 340 of the metal layer 315 and the VO₂ layer 320 is connected to the second electrode 335. The line 340 forms a U-shaped pattern as the line 340 connects to the first electrode 330 and the second electrode 335.

The first electrode 330 and the second electrode 335 are disposed on the substrate, with metal layer 315 being disposed on the substrate and the VO₂ layer 320 being disposed on the metal layer 315. The line 340 of the metal layer 315 and the VO₂ layer 320 may be considered to have two portions; a first portion 345 of the line disposed on the sacrificial layer 310, and a second portion 350 of the line not being disposed on the sacrificial layer and being unsupported or in free space.

As shown in FIG. 3A, the U-shaped pattern may comprise substantially straight lines and substantially right angles (i.e., the U-shaped pattern may not be a curved U). In some embodiments, a width of the line 340 of the metal layer 315 and the VO₂ layer 320 is about 2 microns to 20 microns, or about 5 microns. In some embodiments, a length of the U-shaped pattern (i.e., a length of the first portion 345 and the second portion 350) is about 10 microns to 500 microns. In some embodiments, a width 360 of the U-shaped pattern is about 5 microns to 100 microns.

In some embodiments, the microactuator 300 is configured to receive electrical power though the first electrode 330 and the second electrode 335. When the microactuator receives electrical power through the electrodes, the power heats the vanadium dioxide layer and the metal layer and causes actuation of the second portion 350 of the line forming the U-shaped pattern. The electrical power may be a current of about 100 microamps to 10 milliamps, and a voltage of about 0.1 volts (V) to 10 V.

Other configurations of microactuators can also be fabricated. FIG. 3C shows a top-down schematic illustration of a microactuator 370. In some embodiments, the microactuator 370 may be similar to the microactuator 300 shown in FIG. 3A.

In the top-down view of the microactuator 370 shown in FIG. 3C, the substrate 305, the sacrificial layer 310, and the VO₂ layer 320 are visible. Not visible is the metal layer 315, as it is covered by the VO₂ layer 320. The metal layer 315 and the VO₂ layer 320 form a pattern including a first electrode 372, a second electrode 374, and a line 376. A first end of the line 376 of the metal layer 315 and the VO₂ layer 320 is connected to the first electrode 372, and a second end of the line 376 of the metal layer 315 and the VO₂ layer 320 is connected to the second electrode 374. The line 376 forms a V-shaped pattern having a blunt or flat tip as the line 376 connects to the first electrode 372 and the second electrode 374. In some embodiments, the blunt or flat tip is substantially parallel to an edge of the sacrificial layer 310.

The first electrode 372 and the second electrode 374 are disposed on the substrate, with metal layer 315 being disposed on the substrate and the VO₂ layer 320 being disposed on the metal layer 315. The line 376 of the metal layer 315 and the VO₂ layer 320 may be considered to have two portions; a first portion of the line disposed on the sacrificial layer 310, and a second portion of the line not being disposed on the sacrificial layer and being unsupported or in free space.

As shown in FIG. 3C, the V-shaped pattern may comprise substantially straight lines extending at an angle from the first electrode 372 and the second electrode 372 and meeting at a blunt or flat tip. In some embodiments, a width of the line 376 of the metal layer 315 and the VO₂ layer 320 is about 2 microns to 20 microns, or about 5 microns.

If the microactuator 370 is fabricated with a metal layer deposition process above about 67° C., the line of the metal layer and the VO₂ layer will form a coil when the microactuator 370 is not actuated. An axial length of the coil is determined by a distance between the first electrode 372 and the second electrode 374. When the microactuator 370 is actuated, the coil will extend and the metal layer and the VO₂ layer will be in a planar configuration. If the microactuator 370 is fabricated with a metal layer deposition process below about 67° C., the actuated and unactuated states of the microactuator 370 will be reversed. The operation of microactuators similar to or the same as the microactuator 370 is described further below in EXAMPLE 2.

In some embodiments, a microactuator does not include a first electrode and a second electrode, but still includes a portion of the VO₂ layer being disposed on the sacrificial layer. The portion of the VO₂ layer disposed on the sacrificial layer may serve to anchor the microactuator, and the microactuator may be actuated using heat from a source (e.g., a laser or a furnace).

### Example 1

The following examples of the fabrication and operation of Cr/VO₂ microactuators, also referred to as bimorphs, are intended to be examples of the embodiments disclosed herein, and are not intended to be limiting.

A set of Cr/VO₂ microactuators with layers in nanoscale thicknesses made using batch microfabrication is described below; the devices exhibit good performance by nearly all metrics. In addition to the high work density output and high response speed expected, they offer the highest displacement-to-length ratio in the sub-100 μm length scale. They respond with high sensitivities to various thermal, electrothermal, and photothermal stimuli, and work with high durability in both ambient and aqueous conditions.

Microactuators were fabricated by patterning and etching Cr/VO₂ double-layer thin films deposited on Si substrates with a 1.1 μm thick thermal oxide (SiO₂). VO₂ films with different thicknesses varying from about 100 nanometers (nm) to 300 nm were prepared by pulsed laser deposition (PLD), and the majority of data described herein are based on a VO₂ thickness of about 118 nm±5 nm. Across the MIT, the as-deposited VO₂ film exhibited a drastic change in resistivity by over two orders of magnitude, as well as a change in optical reflectivity under white light illumination. The Raman spectrum at room temperature showed strong peaks identified as the I phase of VO₂. These peaks decreased in intensity with increasing temperature, and finally disappeared due to metallic nature of the high-temperature M phase.

SiO₂/Si was chosen as a substrate because VO₂ films PLD deposited on the surface of amorphous SiO₂ are textured with the c_{R} axis lying in the plane of the substrate. The structural texturing enables actuation based on VO₂; otherwise, a completely random orientation of micro-grains in the VO₂ film would cause the c_{R}-axis shrinkage to be fully cancelled by the expansion in a_{R} and b_{R} axes. In addition, the SiO₂ layer underneath VO₂ can be selectively removed with wet etching without damaging the VO₂ layer, thereby releasing the VO₂ film layer.

Prior to the etching, Cr was lithographically patterned and deposited onto the VO₂ film by e-beam evaporation, and then rapid thermally annealed at about 150° C. to 300° C. for about 120 seconds. Cr was selected because it wets VO₂ and has a high Young's modulus. The pattern was partially covered with a photoresist. Reactive ion etching (RIE), a dry etching process, was used to etch the exposed parts of VO₂ without significant lateral etching, and the parts of VO₂ protected by either Cr or photoresist remained un-etched. Afterwards, the substrate was immersed in a buffered oxide etchant (BOE 5:1) for a period of time depending on the width of the pattern, so as to under-etch the SiO₂ layer beneath the Cr/VO₂ pattern. As a result, the Cr/VO₂ structures not protected by the photoresist were released from the substrate and became free-standing. Finally, the BOE solution was gradually replaced by water and then acetone to dissolve the photoresist, followed by natural drying in air. The fabrication process is able to make microactuator structures in batch with a wide variety of sizes and arbitrary geometries. The released Cr/VO₂ curved toward the Cr side at room temperature. This is because the Cr was deposited onto VO₂ at a temperature higher than its MIT temperature when it is in the M phase with smaller in-plane lattice constants; as a result, when the Cr/VO₂ becomes free-standing at room temperature, release of the built-in stress causes the structure to bend away from the expanded VO₂ side.

In the PLD of the VO₂ thin films on SiO₂/Si substrates, the Si substrates with 1.1 μm thermal SiO₂ were first cleaned and placed in a PLD chamber. The chamber was pumped to a base pressure of ˜10⁻³ mtorr, and then oxygen was introduced and the pressure stabilized at 10 mtorr. After that, the substrates were heated to 520° C. at a rate of 20° C./min, and then a KrF laser beam (wavelength 248 nm) was focused onto a VO₂ target (99% purity) with an intensity of ˜25 mJ/mm² to deposit the film with a rate of ˜2.6 nm/min. Afterwards the substrates were naturally cooled down at a rate of 10° C./min under the same oxygen pressure.

In the Cr deposition processes, after photolithography, Cr layers were deposited onto the VO₂ thin film by e-beam evaporation at a rate of 2 Å/s. Annealing was carried out in a rapid thermal annealing furnace under Ar environment, for a ramping time of 30 s followed by an annealing time of 120 s at the target temperature.

Reactive ion etch (RIE) of VO₂ was carried out in a mixed gas of SF₆ (90%) and O₂ (10%) with a flow rate of 60 sccm, under a pressure of ˜89 mtorr, and at a working power of 100 W; the etching time was 12 s for the VO₂ films described herein.

The wet etching of SiO₂ used a 5:1 BOE solution with an etching time depending on the width of the Cr/VO₂ structure, which was 25 min˜28 min for the 5 μm width and 45 min˜50 min for the 10 μm width. Build-in stress between the Cr and VO₂ caused the structure to bend towards Cr when released, detaching the Cr/VO₂ structure from the underlying SiO₂ prior to the SiO₂ being completely etched.

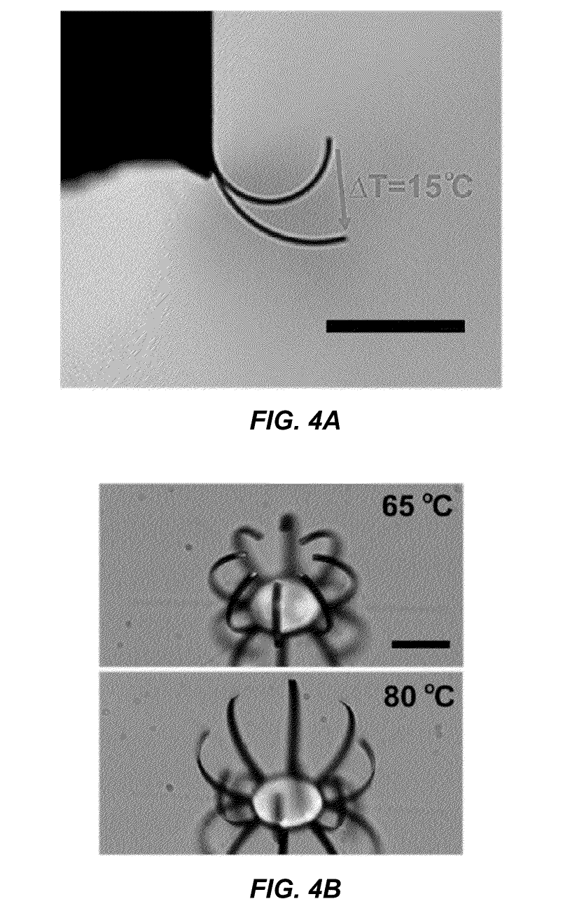

FIGS. 4A and 4B show examples of micrographs of thermally activated bimorph microactuators. The Cr/VO₂ bimorph exhibits a large change in curvature upon the MIT of the VO₂, acting as a thermally driven microactuator offering giant actuation amplitudes. FIG. 4A shows side-view optical image of a cantilevered Cr/VO₂ bimorph at two temperatures 15° C. apart from each other across the MIT. The tip displacement for this 60 μm long bimorph was 36 μm, giving a displacement (D)-to-length (L) ratio of D/L=0.6. With longer bimorphs, a D/L exceeding 0.9 has been achieved. The high D/L is attributed to a change of ˜22,000 m⁻¹ in bimorph curvature across the MIT, which mimics the MIT-induced resistivity change. The curvature change is much higher than bimorphs based on other mechanisms such as differential thermal expansion and piezoelectricity. For such a bimorph with a rectangular cross section, the curvature change Δκ=Δ(1/R) is proportional to the relative length change (strain change Δ∈) of the active layer (VO₂) in the bimorph,

$$Δκ = \frac{6 {E}_{Cr} {E}_{{VO}_{2}} {t}_{Cr} {t}_{{VO}_{2}} ( {t}_{Cr} + {t}_{{VO}_{2}} )}{\begin{matrix}{E}_{Cr}^{2} {t}_{Cr}^{4} + 2 {E}_{Cr} {E}_{{VO}_{2}} {t}_{Cr} {t}_{{VO}_{2}} \\ ( 2 {t}_{Cr}^{2} + 3 {t}_{Cr} {t}_{{VO}_{2}} + 2 {t}_{{VO}_{2}}^{2} ) + {E}_{{VO}_{2}}^{2} {t}_{{VO}_{2}}^{4}\end{matrix}} Δɛ \qquad ( 1 )$$

where E_{Cr}=280 GPa and E_{VO}_{₂}=140 GPa are the Young's modulus of Cr and VO₂ layers, respectively, and t_{Cr} and t_{Vo}_{₂} are their thicknesses. Using this equation, an effective strain change of Δ∈˜0.3% in VO₂ is estimated across the MIT. Although this is lower than the c_{R}-axis transformation strain (1%) in single-crystal VO₂, it is orders of magnitude higher than the strain deployed in existing bimorph actuators, namely, the strain caused by differential thermal expansion (estimated to be ˜0.03% between VO₂ and Cr from 25° C. to 67° C.), and the strain accumulated in piezoelectric materials (typically ˜0.01% at an applied field of 100 V/mm).

The relative actuation amplitude, represented by the tip displacement-to-length ratio D/L, is one of the key metrics for microscale actuation. Giant D/L allows actuators that occupy small volume to drive motion over long distance. The giant D/L of the microactuators disclosed herein, up to unity for L less than 100 μm, is unusually large compared to other actuation techniques. D/L of all existing bimorph actuator technologies is limited to 0.4, despite their lengths exceeding 100 μm. Note that for a cantilever with given amount of change in bending curvature (Δ(1/R)), its tip displacement D is proportional to the cantilever length L squared, instead of L. Therefore, a longer L favors not only higher D, but also higher D/L; thus achieving high D/L is especially challenging for short L. The Cr/VO₂ bimorph actuators provide the highest relative amplitude, especially for the sub-100 μm regime, compared to other actuators. In addition, Eq. (1) indicates that the giant curvature change also benefits from the small thickness of the layers in the bimorph (about 100 nm to 200 nm), as Δκ scales inversely with the thickness. In contrast, SMAs, the only other material competitive to VO₂ in terms of work density, cannot reach deep sub-μm thickness without sacrificing the actuation properties. Note that for certain applications, thicker bimorphs may be needed to offer larger forces or higher work at the cost of actuation amplitude. Given the high Young's modulus and high work density of VO₂, a high force can be achieved at relatively small bimorph thicknesses. There are also effects of Cr thickness and annealing temperature on the actuation amplitude.

In some embodiments, the advantages of the thin film based device fabrication are the size scalability and versatility in designing arbitrary patterns to fit different needs. FIG. 4B shows a palm structure as a microactuator that can be thermally activated. Varying the temperature from room temperature to 80° C. repeatedly opens and closes the palm. Such a structure might be suitable for on-demand capturing and releasing micro-objects.

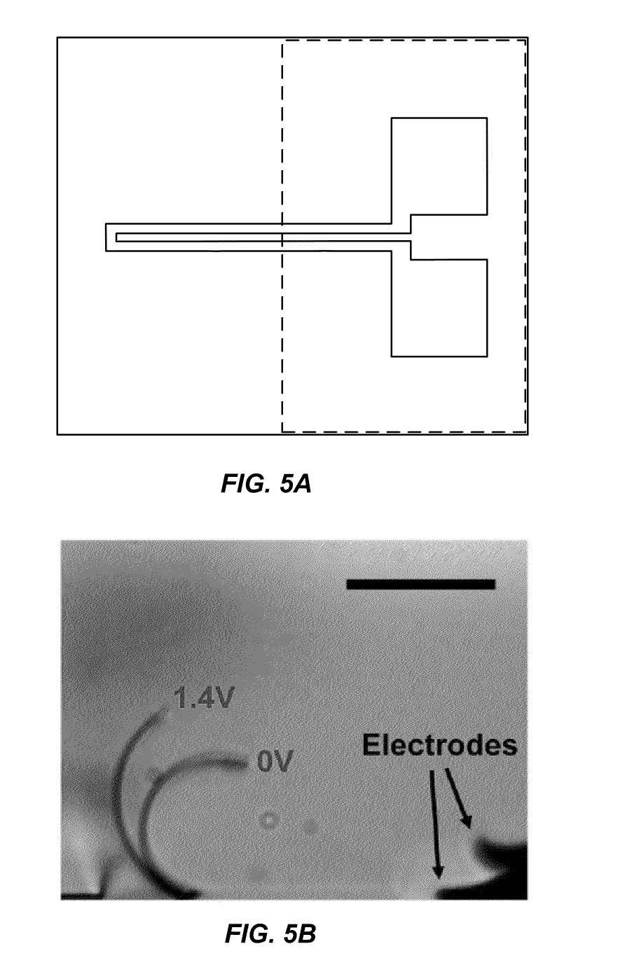

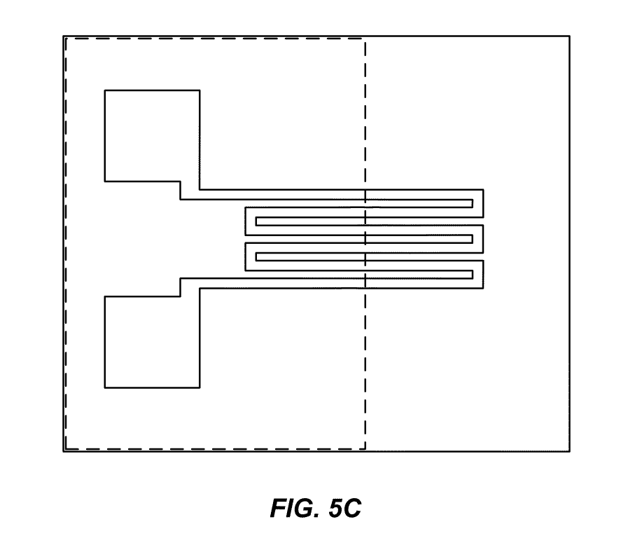

The actuation can be also activated electrothermally with an electric current or photothermally with a focused laser. Such electrical and optical control of the actuation offers capability of addressing individual devices at much higher speed and smaller scale than by global heating. FIG. 5A shows an example of a schematic diagram of a micro-heater actuator patterned out of the Cr/VO₂ bimorph. The part outside the rectangular box will be under-etched and thus free standing. As shown in FIG. 5A, a micro-heater structured actuator utilizes Joule heating of current flowing through the actuator itself to achieve the actuation.

FIG. 5B shows a micrograph of a side view of a micro-heater actuator activated by Joule heating. The microactuator comprises a 50 nm layer of Cr and a 118 nm layer of VO₂. The scale bar in FIG. 5B is 50 μm. As shown in FIG. 5B, owing to good electrical conductivity of the Cr and VO₂ layers, a small applied voltage (1.4 V) makes the actuator bend at its maximum amplitude using a low input power of 1.6 mW. In ambient condition, the curvature changes by ˜14,000 m⁻¹ between the voltage ON and OFF states. The electrical actuation is also completely reversible free of materials fatigue and deterioration. The resistance of the actuator was monitored during operation driven by an applied square-wave voltage alternating between 0.2 V and 1.4 V at a frequency of 0.2 Hz. The resistance changed by 5% between the states under high and low voltages due to the current-controlled MIT of the VO₂ layer. The actuator went through tens of thousands of actuation cycles in air without noticeable degradation in performance, suggesting a long lifetime and high durability.

The dependence of curvature change on the frequency of the square-wave voltage applied was measured. It was seen that the actuation amplitude remains the same until the frequency exceeds 2 kHz. The 3 dB attenuation frequency (where the amplitude is reduced by half) was about 6 kHz, corresponding to a response time of ˜0.17 milliseconds (ms). The actuation was completely cut off at ˜20 kHz, where the pulsed heating becomes faster than the heat dissipation through thermal conduction to the substrate and convection to ambient air. This process is slower than piezoelectrically driven actuators (>tens of kHz), comparable to differential thermal expansion actuators, but much faster than shape memory alloy actuators and any polymer and ionic motion-based actuators (<hundreds of Hz).

FIG. 5C shows an example of a schematic diagram of another configuration of a micro-heater actuator patterned out of the Cr/VO₂ bimorph. The part outside the rectangular box will be under-etched and thus free standing.

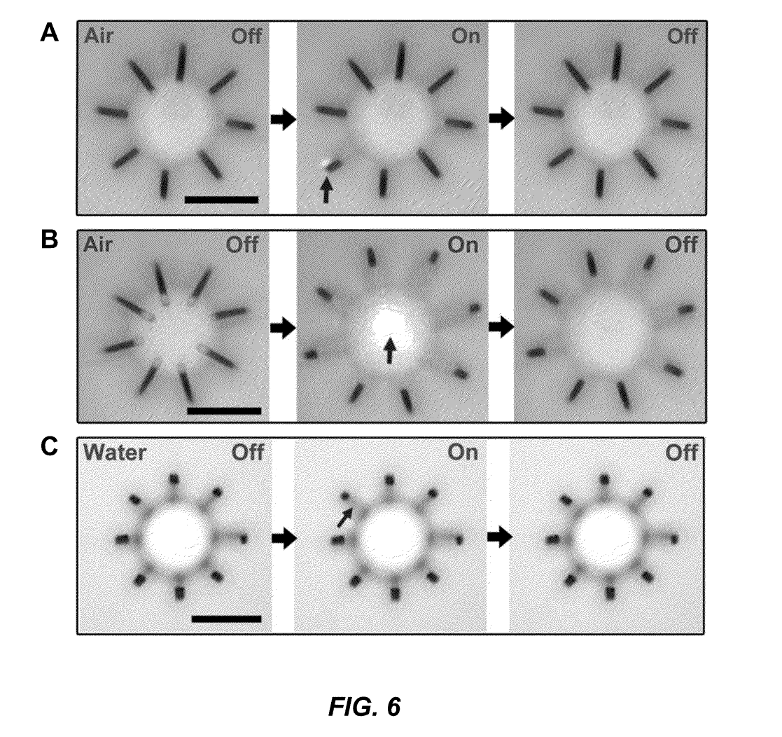

Compared to thermal and electrical activation, light is desired for contactless and spatially resolved control of actuation. FIGS. 6A-6C show examples of micrographs of optically activated bimorph microactuators. The bimorph microactuators shown in FIGS. 6A-6C are in a palm configuration and are activated with a focused laser. As shown in FIG. 6A, the laser can address each finger of the palm individually. The laser power was 4 milliWatts (mW) and substrate temperature was 25° C. The microactuator length was 100 μm, and the scale bar in FIG. 6A is 30 μm.

As shown in FIG. 6B, the laser can also activate the entire palm structure globally. The laser power was 320 milliWatts (mW) and the substrate temperature was 53° C. The microactuator length was 100 μm, and the scale bar in FIG. 6B is 30 μm.

In addition to working in ambient air, the actuator also works well in aqueous environments, as shown in FIG. 6C, where the palm structure is soaked in di-ionized water. FIG. 6C shows the actuation of one finger in 40° C. water with a 5 mW laser. The arrows indicate the laser spots. The microactuator length was 50 μm, and the scale bar in FIG. 6C is 50 μm. The actuation in water was stable and the response speed is faster than 17 ms, the frame interval of the camera used to film the microactuator. This is much faster than other mechanisms currently used in aqueous actuation, such as hydrogel swelling and polymer electrostriction. Therefore, properly designed Cr/VO₂ microactuators may be used for high-speed microfluidic valves/pumps and reversible molecular cargos in physiological environments.

### Example 2

The following examples of the fabrication and operation of Cr/VO₂ microactuators are intended to be examples of the embodiments disclosed herein, and are not intended to be limiting.

Miniaturisation of conventional rotary motors is a great challenge because of their complex design. A piezoelectric ultrasonic micro-motor is a successful alternative, although its size is still on the millimetre scale. Further scaling down requires pursuit of different designs. Although an electrostatically driven microelectromechanical motor was developed twenty years ago, its inherently on-chip structure complicates the integration to drive other devices. A similar mechanism was used to develop carbon nanotube based nanoelectromechanical actuators. A rotary magnetic field was also utilized to actuate the rotation of micro magnetic metal paddles. Torsional muscles using sole or guest-filled twisted carbon nanotube yarns were recently reported. These micro or nanoscale motors, however, all deliver a single function, i.e., torsional motion. For micro-robots in simulation of living organisms, it is much desired to have a micro torsional muscle integrating multifunctions in a limited space, such as simultaneous actuation and sensing. In addition, higher power density, larger rotation amplitude, and higher rotational speed are much desired in these applications.

A micro torsional muscle driven by the phase transition of VO₂, with a simple design but high performance in power density, rotation amplitude, and rotational speed, is described below. The artificial muscle also combines all the functions including torsional actuator, memristor, and proximity sensor, showing great potential in applications that require a high level of functionality integration in a small space.

The micro torsional muscle was fabricated by releasing a long “V”-shaped Cr/VO₂ bimorph structure. VO₂ thin films were first grown by pulsed laser deposition on Si substrates with a 1.1 μm thick thermal oxide. The “V”-shaped Cr pattern was lithographically defined and deposited onto the VO₂ layer, followed by an anneal process. Afterwards, the un-protected area of VO₂ was etched away by reactive ion etching (RIE). Then the “V”-shaped Cr/VO₂ area was covered by photoresist with the same pattern, and the exposed SiO₂ and the underneath Si were deep-etched to a depth of ˜25 μm, both by RIE. Finally, the photoresist was removed, and the SiO₂ layer beneath the Cr/VO₂ was under-etched by buffered oxide etchant, releasing the “V”-shaped Cr/VO₂ bimorph ribbon.

In more detail, VO₂ thin films were grown by pulsed laser deposition on 1.1 μm thick SiO₂/450 μm thick Si substrates, at a laser intensity of 2 J/cm², growth temperature of 520° C., and oxygen pressure of 10 mtorr. “V”-shaped Cr pattern was defined on VO₂ thin films by photolithography, e-beam evaporation, and lift-off process. Annealing was carried out at 300° C. for 2 min in a rapid thermal annealing furnace under an Ar environment. VO₂ was etched by RIE in a mixed gas of SF₆ (90%) and O₂ (10%), under a pressure of ˜90 mtorr, at a working power of 100 W, and with an etch rate of ˜20 nm/s. SiO₂ was deep etched by C₄F₈/H₂ (15/8 sccm) at 4 mtorr under a bias power of 350 W, with an etch rate of ˜0.3 μm/min. Si was deep etched through a Bosch process in which SF₆/O₂ (130/13 sccm, 35 mtorr, 10 s) and C₄F₈ (80 sccm, 18 mtorr, 7 s) were switched regularly for etch and passivation, with an etch rate of ˜2 μm/min. The under-etch of SiO₂ was realized through buffered oxide etchant (BOE 5:1), with an etch rate of ˜100 nm/min.

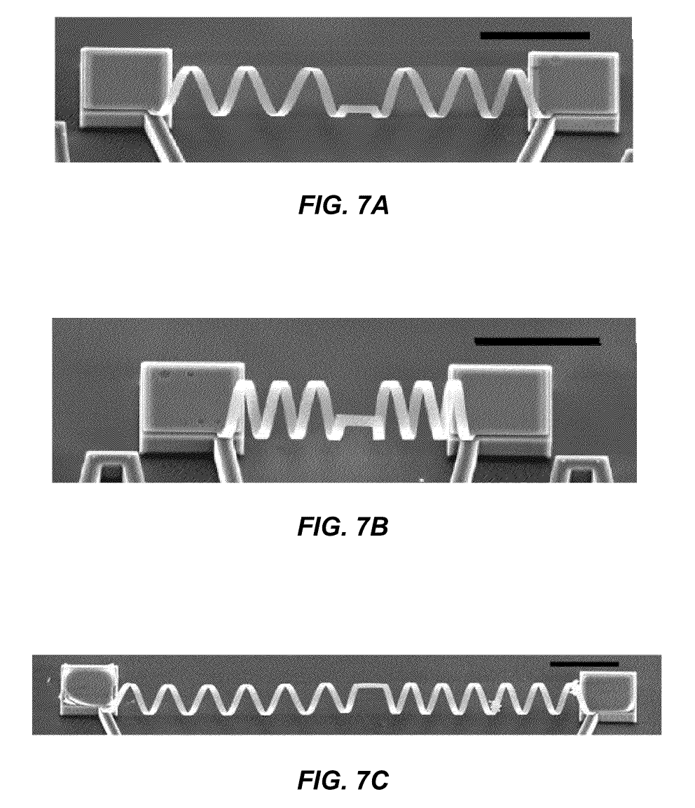

The resultant structure is a suspended bimorph helix consisting of two symmetric coils (thereafter termed as a “dual coil”) naturally connected to the two Cr electrode pads, as shown in FIGS. 7A-7C. The initial curvature originates from the stress built in the metal deposition and annealing processes. The coil diameter depends on the thickness of Cr and VO₂ layers, and can be also tuned by the anneal temperature. The coil axial length and coil ribbon length of the structure are given by the distance between the two electrode pads and the arm length of the “V”-shaped structure, respectively.

The as-fabricated dual coil can be actuated by increasing the temperature of the entire chip (global heating), but more conveniently by Joule heating of current flowing through the coil itself. Such electrical control of actuation can allow addressing individual devices at much higher speed than by global heating. The parallel connection of the VO₂ and Cr layers offers a good electrical conduction and therefore a low work voltage.

A dual coil can rotate to its maximum amplitude under an input voltage of 3.1 V, where the input power is only ˜3 mW. When the driving voltage slowly varies, the coil switches between a high-resistance state corresponding to the insulating phase of VO₂, and a low-resistance one corresponding to its metallic phase. The hysteresis between the forward and backward sweeping results from the intrinsic supercooling and superheating of the phase transition in VO₂. All of the current-voltage curves went through the origin regardless of the sweeping frequency. The area enclosed by the current-voltage loop increased initially as a function of the sweeping frequency, then decreased monotonically after ˜100 Hz, and eventually converged to a straight line obeying the Ohm's law. These are the fingerprints of a memristor, akin to the memristor behaviour of sodium and potassium ion channels, implying potential applications in neuron-mimetic devices. Combined with the structural actuation, these devices may also lead to implementation of mem-inductors and mem-capacitors.

Driving the dual coil with a square-wave input voltage revealed the high speed of actuation. In ambient air, the response time in the switch-on and switch-off step was 0.76 ms and 0.34 ms, respectively. Thus the maximum response frequency for a full cycle of rotation is ˜900 Hz in air (in liquid, it is ˜40 Hz). The rotation amplitude of the dual coil normalized by the coil axial length is ˜2000°/mm, and by the coil ribbon length is ˜500°/mm. This specific amplitude is reduced by half from that of a single coil, but the torque is enhanced by a factor of two. The coil ribbon length-normalized rotational speed is up to 450,000°/s, or 75,000 rpm, per millimetre of ribbon length. This value is 12 to 250 times higher than that of carbon nanotube based torsional muscles, and 1 to 2 orders of magnitude higher than commercial heat engines and electric motors, as well as ultrasonic motors.

A device was driven by a 100 Hz square-wave voltage for one million cycles in ambient air; afterwards both the rotation amplitude and resistance switch show no noticeable degradation, testifying the mechanical and electrical reliability of the device operation. The torque of the coil is estimated to be 6.8 pN·m, which is ˜1.5 N·m/kg for the coil mass of the device. Considering the actuation time of ˜0.34 ms, the peak power density was ˜39 kW/kg. This is ˜200 times higher than that of mammalian skeletal muscles, several to a hundred of times higher than piezoelectric ultrasonic motors, heat engines, and electric motors, and also surpasses that of the recently developed hybrid carbon nanotube yarn muscles.

Unlike electrostatically driven micro-motors, the actuation function of a dual coil device is built upon the internal phase transition of the active material, as opposed to interactions between different device components. The resultant benefit is that the structure can be conveniently removed from the fabrication substrate as an off-chip device without losing the functionalities.

When treating the coil as an elastic spring, its spring constant also varies with the change in geometry. From elastic theory the spring constant for the bimorph coil was calculated and plotted as a function of temperature. With the MIT occurring in the coil, the spring constant for the coil is reduced by about ⅔, from 0.096 N/m at 55° C. to 0.031 N/m at 66° C. The tunability in spring constant can be further widened by optimizing the width and thickness of the Cr/VO₂ bimorph as well as the coil length.

With the high level of power density, the coil can function as a powerful apparatus for output of mechanical energy. For example, a dual coil holding a micro object can throw the object during rapid actuation of the dual coil. The weight and size of the object used in experiments was ˜0.4 μg and ˜50 μm, and the throw distance was ˜1 mm. The torsional actuator therefore catapulted a weight ˜50 times heavier than itself for a distance of ˜5 times longer than itself, in a period of time shorter than 60 ms. Another way to output mechanical energy is through the expansion of the enclosed volume of the coil. With the increase of diameter during the actuation, the volume of the coil rapidly increases by 2 to 3 times in ˜1 ms, capable of pushing outward heavy objects surrounding it.

Besides the powerful mechanical function, VO₂ is also an electrically and optically active material responding sensitively to environment temperature, which provides the coil with additional sensing functions. For example, the coil can function as a non-contact micro proximity sensor, where the coil is heated by Joule heating. Proximity to a room-temperature micro-object slightly reduces local temperature of the coil; the coil senses the distance by a change in its resistance. The resistance of the coil sensor changes by only ˜0.4% in the purely metallic phase. In contrast, the sensitivity is much higher for the device working in the phase transition regime, with a resistance change of ˜2.5%, but with a small hysteresis.

The naturally combined functions of proximity sensing and torsional motion allow for the device to remotely detect a target and respond by reconfiguring itself to a different shape. This simulates living bodies where muscles and neurons work together to deliver the full activity: neurons sense and deliver stimuli to the muscles and the muscles provide motion. Considering the built-in memristive behaviour, it is also possible to simulate active learning process with the devices.

### CONCLUSION

In summary, VO₂-based microactuators with defined designs may be fabricated in batch, and show giant normalized amplitude over a small temperature rise, especially at sub-100 μm length scales. The large normalized actuation amplitude (D/L) directly benefits from the giant strain across the phase transition, as well as the nanoscale thickness of the devices. Even if the length of the actuator scales down to 1 μm, its tip would still displace by more than 10 nm. Using the strain change of Δ∈=0.3% observed in the VO₂ films described herein, a work density as high as 0.63 J/cm³ is calculated. As a comparison, the work density would be ˜0.001-0.01 J/cm³ for the differential thermal expansion actuators (ΔT=10K) and typical piezoelectric actuators. Therefore, the microactuators described herein offer not only large displacement, but also high work output; consequently, a high actuation force is expected without being compromised by the large displacement.

The microfabrication process described herein is versatile, scalable, and compatible with industry standards. The functionalities of actuation can be further enriched with integrated designs of planar as well as three-dimensional geometries. The diverse range of stimuli that the devices respond to greatly extends the speed and individual addressability of the microactuators. Taken together, a wide range of micro- and nano-scale applications can be envisioned where mechanical motion is needed at high displacement, high force, and high speed, such as micro-manipulation, optomechanical and electromechanical switches, microfluidic valving and pumping, drug delivery, heat regulation, and artificial muscles.

Further description of the subject matter disclosed herein may be found in the following publications, all of which are herein incorporated by reference:
“Giant-Amplitude, High-Work Density Microactuators with Phase Transition Activated Nanolayer Bimorphs,” by Kai Liu, Chun Cheng, Zhenting Cheng, Kevin Wang, Ramamoorthy Ramesh, and Junqiao Wu, Nano Lett., 2012, 12 (12), pp 6302-6308;
“Performance Limits of Microactuation with Vanadium Dioxide as a Solid Engine,” by Kevin Wang, Chun Cheng, Edy Cardona, Jingyang Guan, Kai Liu, and Junqiao Wu, ACS Nano, 2013, 7 (3), pp 2266-2272; and
J. Cao, Wen Fan, Qin Zhou, Erica Sheu, Aiwen Liu, C. Barrett, and J. Wu, Colossal Thermal-Mechanical Actuation via Phase Transition in VO2 Microcantilevers; J. Appl. Phys., 108, 083538 (2010).

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
(a) depositing a vanadium dioxide layer on a sacrificial layer disposed on a substrate;
(b) depositing a metal layer on the vanadium dioxide layer;
(c) patterning the metal layer;
(d) removing portions of the vanadium dioxide layer that are not covered by the metal layer; and
(e) removing at least a portion of the sacrificial layer to form a cantilever-type structure including the vanadium dioxide layer and the metal layer disposed on the vanadium dioxide layer.

2. The method of claim 1, further comprising:
after operation (c), thermally annealing the metal layer at about 150° C. to 500° C. for about 60 seconds to 180 seconds.

3. The method of claim 1, further comprising:
before operation (d), depositing a photoresist on a portion of the metal layer and the vanadium dioxide layer;
in operation (d), removing portions of the vanadium dioxide layer that are not covered by the metal layer and the photoresist; and
after operation (e), removing the photoresist.

4. The method of claim 1, further comprising:
(f) attaching a polymer layer to the structure.

5. The method of claim 1, wherein the sacrificial layer disposed on the substrate is disposed on an entire side of the substrate, and wherein the vanadium dioxide layer is deposited on the sacrificial layer to completely cover the sacrificial layer in operation (a).

6. The method of claim 1, wherein the sacrificial layer comprises silicon dioxide.

7. The method of claim 1, wherein the vanadium dioxide layer is about 50 nanometers to 1 micron thick.

8. The method of claim 1, wherein a metal of the metal layer is selected from a group consisting of chromium, nickel, and titanium.

9. The method of claim 1, wherein the metal layer is about 15 nanometer to 500 nanometers thick.

10. The method of claim 1, wherein the vanadium dioxide layer is deposited using a pulsed laser deposition process.

11. The method of claim 1, wherein the metal layer is deposited using a physical vapor deposition process.

12. The method of claim 1, wherein the sacrificial layer is about 0.1 microns to 20 microns thick.

13. A device comprising:
a vanadium dioxide layer;
a metal layer disposed on the vanadium dioxide layer, the vanadium dioxide layer and the metal layer forming a pattern including a first electrode, a second electrode, and a line, a first end of the line connected to the first electrode and the second end of the line connected to the second electrode, the line forming a U-shaped pattern;
a substrate; and
an sacrificial layer disposed on a portion of the substrate, the vanadium dioxide layer of the first electrode, the second electrode, a first portion of the line forming the U-shaped pattern being disposed on the sacrificial layer, and a second portion of the line forming the U-shaped pattern being in free space.

14. The device of claim 12, wherein the U-shaped pattern is about 10 microns to 500 microns long, wherein the U-shaped pattern is about 5 microns to 100 microns wide.

15. The device of claim 13, wherein the line forming the U-shaped pattern is about 2 microns to 20 microns wide.

16. The device of claim 13, wherein the device is configured to:
receive electrical power though the first electrode and the second electrode, wherein the electrical power heats the vanadium dioxide layer and the metal layer and causes actuation of the second portion of the line forming the U-shaped pattern.

17. The device of claim 13, wherein the vanadium dioxide layer is about 50 nanometers to 1 micron thick.

18. The device of claim 13, wherein the metal of the metal layer is selected from a group consisting of chromium, nickel, and titanium.

19. The device of claim 13, wherein the metal layer is about 15 nanometers to 500 nanometers thick.

20. The device of claim 13, wherein the sacrificial layer is about 0.1 microns to 20 microns thick, and wherein the sacrificial layer comprises silicon oxide.
